(19) United States
(12) Patent Application Publication
(10) Pub. No.: US 2026/0011843 A1
(43) Pub. Date: Jan. 8, 2026

(54) ELECTRICITY STORAGE APPARATUS

(71) Applicant: TOYOTA JIDOSHA KABUSHIKI KAISHA, Toyota-shi Aichi-ken (JP)

(72) Inventors: Shinya ISHIKAWA, Anjo-shi Aichi-ken (JP); Yusuke KINTSU, Miyoshi-shi Aichi-ken (JP); Takumi TANAKA, Toyota-shi Aichi-ken (JP); Masayoshi HAGA, Nagoya-shi Aichi-ken (JP); Kazuki MURAISHI, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/238,753

(22) Filed: Jun. 16, 2025

(30) Foreign Application Priority Data
Jul. 5, 2024 (JP) 2024-108769

(51) Int. Cl. H01M 50/242; H01M 50/209

(52) U.S. Cl. CPC H01M 50/242; H01M 50/209; H01M 2220/20

(57) ABSTRACT

In an electricity storage apparatus, a housing houses an electricity storage module that includes cells. Each of the cells has a shape longer in a width direction than in a height direction and a thickness direction. An end in the width direction is provided with an electrode terminal. The housing includes an upper case and a lower case including a bottom wall, a pair of end walls, and a pair of side walls. Each of the end walls includes a facing face facing the electrode terminal. The electricity storage apparatus has a restraint mechanism that restrains damage of the electrode terminal. The restraint mechanism has at least one of a rib extending from at least one of the facing faces toward the electricity storage module and a shape of at least one of the facing faces extending outward in the width direction from the bottom wall toward an upper side.

### CROSS-REFERENCE TO RELATED APPLICATION

This application claims priority to Japanese Patent Application No. 2024-108769 filed on Jul. 5, 2024. The disclosure of the above-identified application, including the specification, drawings, and claims, is incorporated by reference herein in its entirety.

### BACKGROUND

### 1. Technical Field

The present disclosure relates to an electricity storage apparatus.

### 2. Description of Related Art

Japanese Unexamined Patent Application Publication No. 2008-166148 (JP 2008-166148 A) discloses an electricity storage apparatus including a case and an electricity storage module that includes a plurality of cells stacked and is housed in the case.

### SUMMARY

An electricity storage apparatus (may be referred to as “battery pack”) includes a housing, and an electricity storage module. The housing houses the electricity storage module. The electricity storage module may include a plurality of cells, and an electrode terminal. The electrode terminal projects to the outside of a cell case. When the electrode terminal faces a side face of the housing, an impact applied to the housing may deform the housing, which may damage the electrode terminal and cause a short circuit.

It is an object of the present disclosure to restrain damage of an electrode terminal.

Hereinbelow, the technical configuration and the actions and effects of the present disclosure will be described. Note that the action mechanism includes estimation. The action mechanism does not limit the technical scope of the present disclosure.

A first aspect of the present disclosure relates to an electricity storage apparatus including an electricity storage module, and a housing. The housing houses the electricity storage module. The electricity storage module includes a plurality of cells. Each of the cells has a height direction, a width direction, and a thickness direction. Each of the cells has a shape that is longer in the width direction than in the height direction and the thickness direction. An end in the width direction is provided with an electrode terminal. The housing includes an upper case and a lower case. The upper case includes a top wall. The lower case includes a bottom wall, a pair of end walls, and a pair of side walls. The bottom wall faces the top wall. Each of the end walls includes a facing face facing the electrode terminal. The electricity storage apparatus has a restraint mechanism that restrains damage of the electrode terminal. The restraint mechanism has at least one of a rib extending from at least one of the facing faces toward the electricity storage module and a shape of at least one of the facing faces extending outward in the width direction from the bottom wall toward an upper side.

The electricity storage apparatus has the restraint mechanism that restrains damage of the electrode terminal. The restraint mechanism has at least one of the rib extending from at least one of the facing faces toward the electricity storage module and the shape of at least one of the facing faces extending outward in the width direction from the bottom wall toward the upper side. Having such a restraint mechanism reduces the deformation of the lower case of the housing when an impact is applied to the lower case from the outside, and also restrains damage of the electrode terminal.

According to a second aspect of the present disclosure, in the electricity storage apparatus according to the first aspect, the restraint mechanism may be configured to face outward of a vehicle when the electricity storage apparatus is mounted on the vehicle.

According to a third aspect of the present disclosure, in the electricity storage apparatus according to the first or second aspect, the cells may be stacked in the thickness direction. Between adjacent ones of the cells, a bus bar may connect the adjacent cells to each other. The end walls may include a first end wall, and a second end wall. The first end wall may include a first facing face facing the electrode terminal. The second end wall may include a second facing face facing the electrode terminal. The second end wall may face the first end wall. The second facing face may face the first facing face. The electricity storage apparatus may be provided with a first rib extending from the first facing face toward the electricity storage module, and a second rib extending from the second facing face toward the electricity storage module. In adjacent ones of the cells, the first rib may be provided facing one of the adjacent cells, and the second rib may be provided facing the other one of the adjacent cells.

According to a fourth aspect of the present disclosure, in the electricity storage apparatus according to any one of the first to third aspects, a wire harness may be provided in a space between at least one of the facing faces and the electricity storage module.

Hereinbelow, an embodiment of the present disclosure (hereinbelow, may be referred to as “the present embodiment” in an abbreviated manner) will be described. However, the present embodiment does not limit the technical scope of the present disclosure. The present embodiment is illustrative in all respects. The present embodiment is not restrictive. The technical scope of the present disclosure includes all changes within the meaning and range equivalent to the claims. For example, it is also intended from the outset to extract any configurations from the present embodiment and combine them in any manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing an example of a vehicle in the present embodiment;

FIG. 2 is a schematic perspective view showing an example of an electricity storage apparatus in the present embodiment;

FIG. 3 is a side view showing an example of an electricity storage module in the present embodiment;

FIG. 4 is a schematic diagram showing an example of a cell in the present embodiment;

FIG. 5 is a schematic sectional view showing the example of the electricity storage apparatus in the present embodiment;

FIG. 6 is a schematic plan view showing the example of the electricity storage apparatus in the present embodiment;

FIG. 7 is a schematic plan view showing another example of the electricity storage apparatus in the present embodiment;

FIG. 8A is a schematic sectional view showing another example of the electricity storage apparatus in the present embodiment; and

FIG. 8B is a schematic sectional view showing another example of the electricity storage apparatus in the present embodiment.

### DETAILED DESCRIPTION OF EMBODIMENTS

### Terms and Phrases

The terms “comprising”, “including”, “having” and their variations are open-ended terms. The open-ended term may further include an additional element or does not have to include an additional element. The phrase “consisting of” is a closed term. However, a configuration expressed in a closed term may include an additional element such as a normally accompanying impurity or an element that is unrelated to the target technique. The phrase “substantially consisting of . . . ” is a semi-closed term. In the semi-closed term, the addition of an element that substantially does not affect the basic and novel characteristics of the target technique is permitted.

Expressions such as “may” and “can” are used as permissive meaning “having possibility”, rather than as obligatory meaning “have to”.

Geometrical terms should not be interpreted as strict meaning. Examples of the geometrical terms include “parallel”, “perpendicular”, and “orthogonal”. For example, direction, angle, and distance may be relatively displaced within the range in which substantially the same or similar functions can be obtained. The geometrical terms can include, for example, tolerances and errors in design, operation, and manufacturing. The dimensional relationships in each drawing may not coincide with the actual dimensional relationships. The dimensional relationships in each drawing may be changed to facilitate the reader's understanding. For example, length, width, and thickness may be changed. Some of the configurations may be omitted.

Unless otherwise specified, an element in the “singular form” may also include the plural form. For example, the term “cell” may also refer to a plurality of cells (a cell group).

The term “cell” refers to a single battery. The cell may be, for example, a lithium ion battery. The cell may contain, for example, a liquid electrolyte (electrolytic solution), a gel electrolyte, or a solid electrolyte.

The term “electrode” is a general term for a positive electrode and a negative electrode. Thus, for example, the term “electrode terminal” is a general term for a positive electrode terminal and a negative electrode terminal.

In the present embodiment, an electricity storage apparatus “for a vehicle” is described. However, the use for a vehicle is merely an example. The use may be any use.

The thickness direction (T-direction), the width direction (W-direction), and the height direction (H-direction) in each drawing are based on the T-direction, the W-direction, and the H-direction of the cell.

### Electricity Storage Apparatus

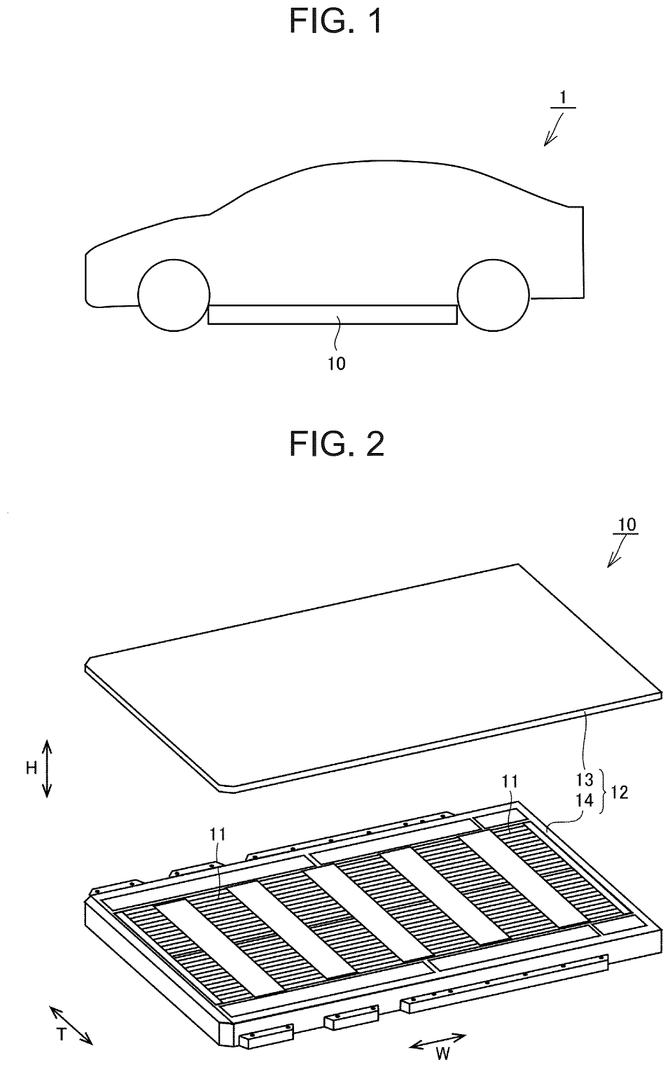

FIG. 1 is a conceptual diagram showing an example of a vehicle in the present embodiment. A vehicle 1 may be, for example, a battery electric vehicle (BEV), a hybrid electric vehicle (HEV), or a plug-in hybrid electric vehicle (PHEV). The vehicle 1 includes an electricity storage apparatus 10. The electricity storage apparatus 10 may be mounted at any position. For example, the electricity storage apparatus 10 may be disposed under the floor of the vehicle 1.

FIG. 2 is a schematic perspective view showing an example of the electricity storage apparatus in the present embodiment. The electricity storage apparatus 10 includes an electricity storage module 11 and a housing 12. The electricity storage apparatus 10 may include a plurality of electricity storage modules 11. The electricity storage apparatus 10 may include, for example, two or more, four or more, or six or more electricity storage modules 11. The electricity storage apparatus 10 may include, for example, eight or fewer, six or fewer, or four or fewer electricity storage modules 11.

A clearance may be present between the electricity storage modules 11. For example, a partition plate (not shown) may be provided between the electricity storage modules 11.

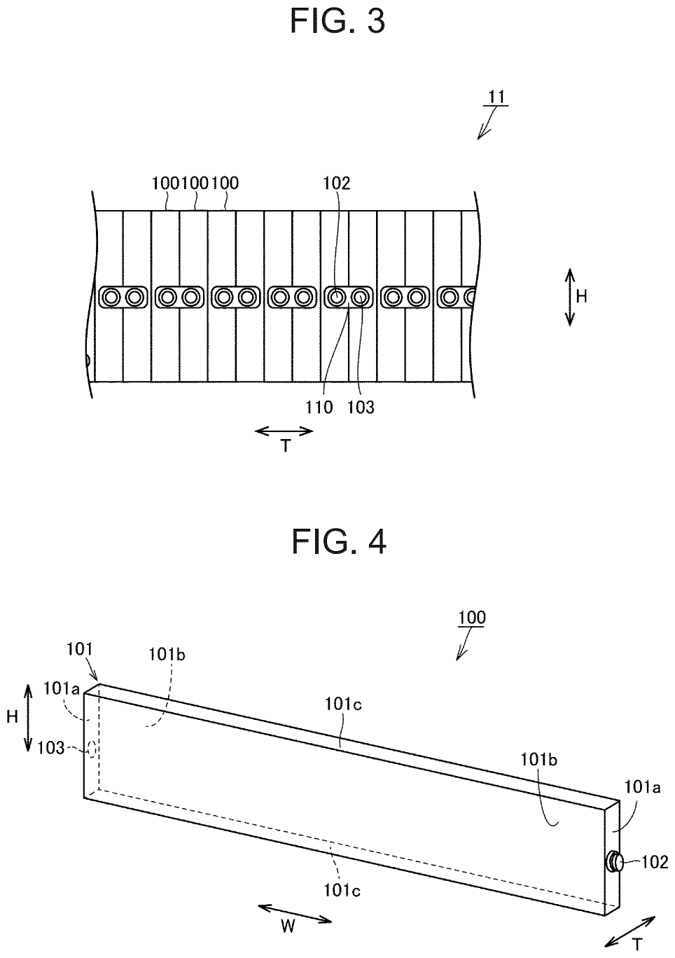

FIG. 3 is a side view showing an example of the electricity storage module in the present embodiment. The electricity storage module 11 includes a plurality of cells 100, and a bus bar 110. The number of cells 100 may be, for example, 2 or more, 4 or more, or more, 20 or more, 50 or more, or 100 or more. The number of cells 100 may be, for example, 100 or less, 50 or less, 20 or less, 10 or less, or 4 or less.

The cells 100 are stacked in the T-direction. The cells 100 are stacked such that connection faces 101b of the cells 100 that are adjacent to each other face each other. The adjacent cells 100 are in an inverted relationship in the W-direction such that a positive electrode terminal 102 of one of the adjacent cells 100 is adjacent to a negative electrode terminal 103 of the other one of the adjacent cells 100.

The bus bar 110 has electrical conductivity. The bus bar 110 may be made of, for example, metal. The bus bar 110 may contain, for example, aluminum (Al), or copper (Cu). The bus bar 110 connects the electrode terminals to each other between the cells 100. The bus bar 110 may connect, for example, the positive electrode terminal 102 and the negative electrode terminal 103 to each other. The bus bar 110 may connect, for example, the positive electrode terminal 102 and the positive electrode terminal 102 to each other. The bus bar 110 may connect, for example, the negative electrode terminal 103 and the negative electrode terminal 103 to each other. The bus bar 110 may be joined to the electrode terminals. For example, the bus bar 110 may be joined to the electrode terminals by resistance welding, ultrasonic bonding, or laser welding.

As shown in FIG. 3, the bus bar 110 may, for example, extend parallel to the T-direction. The bus bar 110 may, for example, be tilted in the H-direction.

FIG. 4 is a schematic diagram showing an example of the cell in the present embodiment. Each of the cells 100 includes a rectangular case 101, the positive electrode terminal 102, the negative electrode terminal 103, and an electric power generating element. The rectangular case 101 houses the electric power generating element. The electric power generating element is also referred to as the “electrode element”. The electric power generating element may include, for example, a positive electrode, a negative electrode, a separator, and an electrolyte. The electric power generating element may be, for example, a stacked type or a wound type. The positive electrode and the negative electrode may have a sheet shape. The positive electrode may contain, for example, lithium iron phosphate, or lithium nickel composite oxide. The negative electrode may contain graphite, silicon oxide, or silicon.

The rectangular case 101 may be made of, for example, metal. The rectangular case 101 may contain, for example, Al.

Each of the cells 100 (rectangular case 101) has a height direction, a width direction, and a thickness direction. The height direction indicates an outer dimension in the H-direction. The width direction indicates an outer dimension in the W-direction. The thickness direction indicates an outer dimension in the T-direction. The height direction, the width direction, and the thickness direction are perpendicular to each other. Each of the cells 100 has a shape that is longer in the width direction than in the height direction and the thickness direction. Each of the cells 100 has a shape that is shorter in the thickness direction than in the height direction.

The width of the rectangular case 101 may be, for example, 500 mm or more, 750 mm or more, or 1000 mm or more. The width of the rectangular case 101 may be, for example, 2000 mm or less, 1500 mm or less, or 1250 mm or less. The height of the rectangular case 101 may be, for example, 50 mm or more, 75 mm or more, or 100 mm or more. The height of the rectangular case 101 may be, for example, 200 mm or less, 150 mm or less, 125 mm or less, or 100 mm or less. The thickness of the rectangular case 101 may be, for example, 5 mm or more, 10 mm or more, 15 mm or more, or 20 mm or more. The thickness of the rectangular case 101 may be, for example, 30 mm or less, 25 mm or less, 20 mm or less, 15 mm or less, or 10 mm or less.

The ratio of the width to the height may be, for example, from 5 to 20. The ratio of the width to the thickness may be, for example, from 50 to 200.

The rectangular case 101 includes six faces. Each face may be a flat face or a curved face. The outer face of the rectangular case 101 includes a pair of terminal faces 101a, a pair of connection faces 101b, and a pair of bottom faces 101c. Each pair of faces may have the same shape or may have different shapes. Each joint (corner) between the faces may be sharp or rounded.

The connection faces 101b have a rectangular shape. Of the six faces, the connection faces 101b have the largest area. The connection faces 101b have a long side direction and a short side direction. In FIG. 4, the long side direction is the W-direction. The short side direction is in the H-direction. The connection faces 101b extend in the long side direction. The terminal faces 101a intersect the long side direction. The terminal faces 101a may be perpendicular to the long side direction. The terminal faces 101a are connected to the connection faces 101b at ends in the long side direction. The bottom faces 101c intersect the short side direction. The bottom faces 101c may be perpendicular to the short side direction. The bottom faces 101c are connected to the connection faces 101b at ends in the short side direction.

The electrode terminals (the positive electrode terminal 102 and the negative electrode terminal 103) are provided on the ends in the width direction, that is, the terminal faces 101a.

The positive electrode terminal 102 penetrates the terminal face 101a. Inside the rectangular case 101, the positive electrode terminal 102 is electrically connected to the positive electrode (electric power generating element). The positive electrode terminal 102 projects in the direction aligned with the long side direction (W-direction) from the terminal face 101a to the outside of the rectangular case 101. Note that the “direction aligned with the long side direction” includes all directions other than the short side direction (the direction perpendicular to the long side direction). The direction aligned with the long side direction may be, for example, parallel to the long side direction.

The negative electrode terminal 103 penetrates the terminal face 101a. Inside the rectangular case 101, the negative electrode terminal 103 is electrically connected to the negative electrode (electric power generating element). In FIG. 4, the negative electrode terminal 103 projects in the direction opposite to the positive electrode terminal 102. In an embodiment, the negative electrode terminal 103 may project in the same direction as the positive electrode terminal 102. That is, both of the positive electrode terminal 102 and the negative electrode terminal 103 may be disposed on the same terminal face 101a.

As shown in FIG. 4, the position of the negative electrode terminal 103 in the H-direction may be the same as the position of the positive electrode terminal 102. The position of the negative electrode terminal 103 in the H-direction may differ from the position of the positive electrode terminal 102.

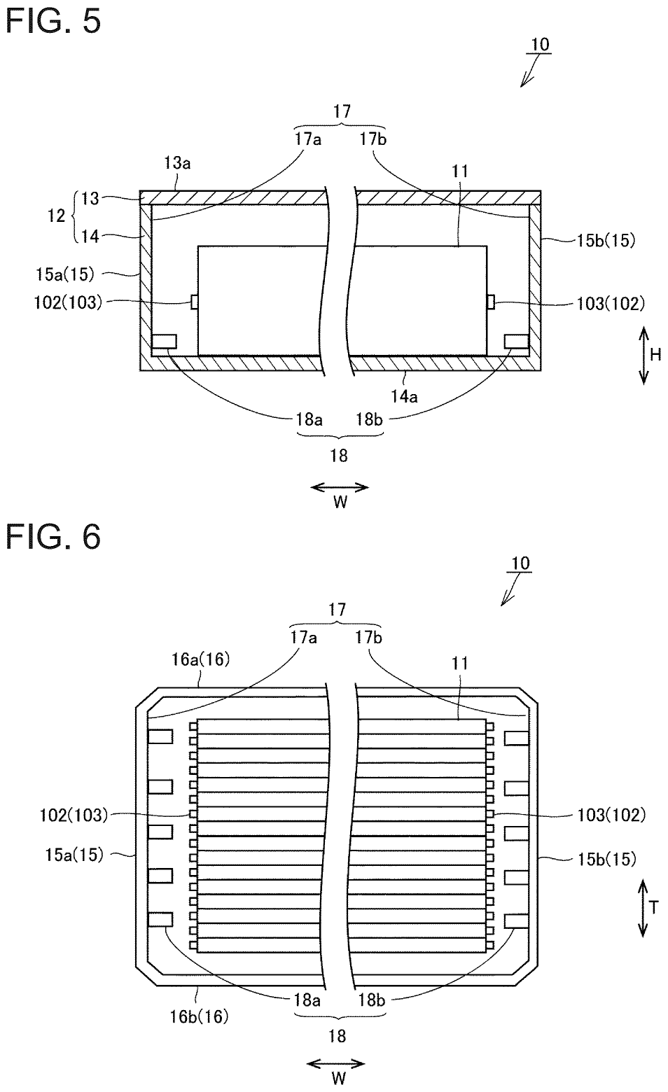

Referring to FIGS. 5 to 8B, the housing 12 houses the electricity storage module 11. The housing 12 may be made of, for example, metal. A rib 18, which will be described further below, may be made of the same material as the housing 12. The housing 12 includes an upper case 13 and a lower case 14. The upper case 13 includes a top wall 13a.

The lower case 14 includes a bottom wall 14a, a pair of end walls 15, and a pair of side walls 16. The bottom wall 14a is disposed under the electricity storage modules 11. The bottom wall 14a faces the top wall 13a. The end walls 15 include a first end wall 15a and a second end wall 15b. The second end wall 15b faces the first end wall 15a. The side walls 16 include a side wall 16a and a side wall 16b. The side wall 16b faces the side wall 16a. The end walls 15 and the side walls 16 extend upward from a peripheral edge of the bottom wall 14a, and constitute a peripheral wall of the lower case 14. Each of the end walls 15 includes a facing face 17 that faces the electrode terminal. That is, the first end wall 15a includes a first facing face 17a, and the second end wall 15b includes a second facing face 17b. The second facing face 17b faces the first facing face 17a.

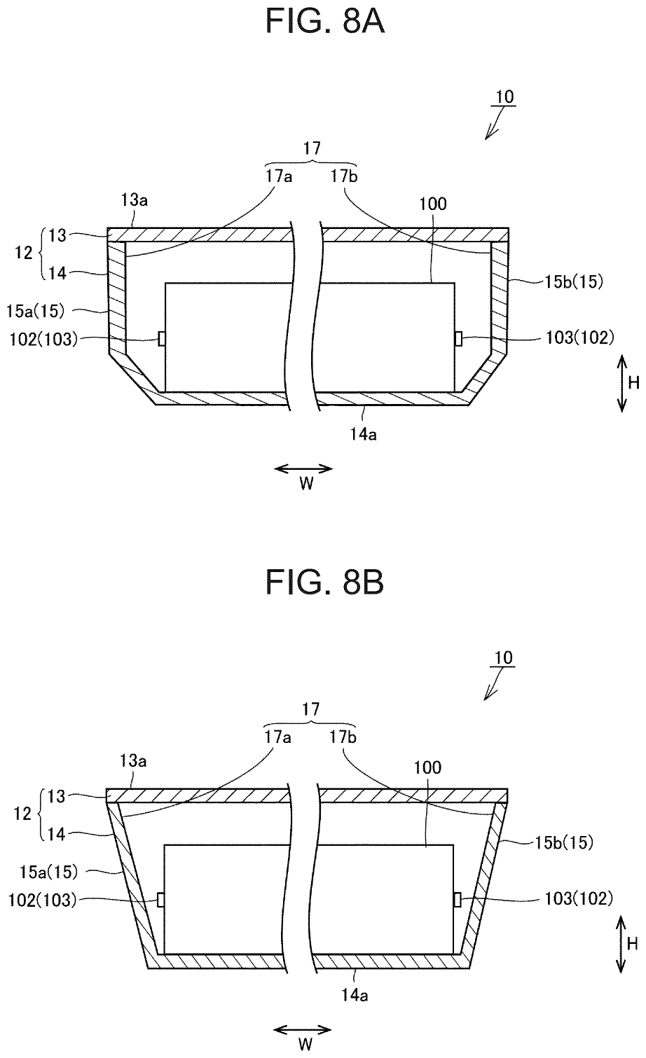

The electricity storage apparatus 10 has a restraint mechanism that restrains damage of the electrode terminals. The restraint mechanism has at least one of the rib 18 (hereinbelow, also referred to as the “first restraint mechanism”) that extends from at least one of the facing faces 17 toward the electricity storage module 11, and a shape of at least one of the facing faces 17 (hereinbelow, also referred to as the “second restraint mechanism”) that extends outward in the width direction from the bottom wall 14a toward the upper side. Having such a restraint mechanism reduces the deformation of the lower case 14 when an impact is applied to the lower case 14 from the outside, and also restrains damage of the electrode terminals. The electricity storage apparatus 10 may have both of the first restraint mechanism and the second restraint mechanism. FIGS. 5 to 7 are diagrams for describing the first restraint mechanism, and FIGS. 8A and 8B are diagrams for describing the second restraint mechanism.

In the first restraint mechanism, it is only required that the rib 18 extend from at least one of the facing faces 17 toward the electricity storage module 11. That is, a first rib 18a may extend from the first facing face 17a toward the electricity storage module 11, or a second rib 18b may extend from the second facing face 17b toward the electricity storage module 11. The ribs 18 may extend from both the facing faces 17 toward the electricity storage module 11.

It is only required that at least one rib 18 be provided on at least one of the facing faces 17. That is, one first rib 18a may be provided on the first facing face 17a, or one second rib 18b may be provided on the second facing face 17b. A plurality of first ribs 18a may be provided on the first facing face 17a, or a plurality of second ribs 18b may be provided on the second facing face 17b. One rib 18 may be provided on each of the facing faces 17, or a plurality of ribs 18 may be provided on each of the facing faces 17. The number of first ribs 18a and the number of second ribs 18b may be the same as each other or may differ from each other.

The first rib 18a and the second rib 18b may be provided at the same position or different positions in the H-direction. The first rib 18a and the second rib 18b may have the same height or different heights in the H-direction. The first rib 18a and the second rib 18b may have the same width or different widths in the W-direction. The first rib 18a and the second rib 18b may have the same thickness or different thicknesses in the T-direction.

The rib 18 and the electrode terminal may be provided at the same position or different positions in the H-direction. The rib 18 may be provided at a position higher than the electrode terminal or at a position lower than the electrode terminal in the H-direction.

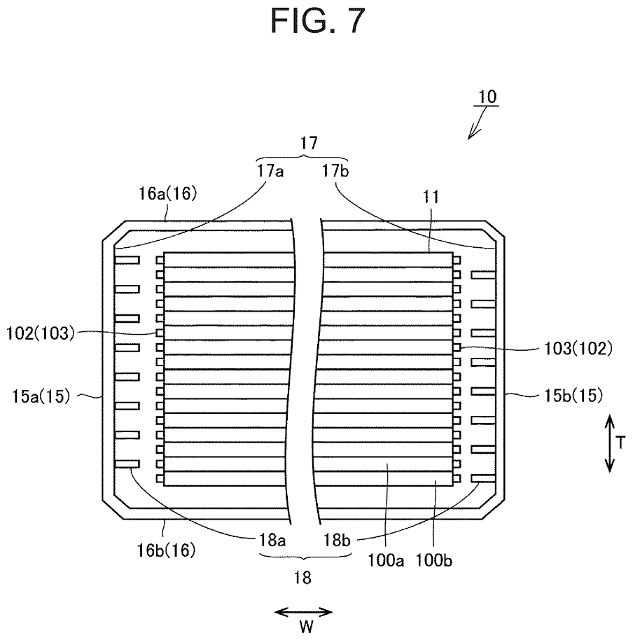

As shown in FIG. 7, in two adjacent cells 100, the first rib 18a may be provided facing one of the cells 100a, and the second rib 18b may be provided facing the other one of the cells 100b. Accordingly, when an impact is applied to the lower case 14 from at least one side in the W-direction, the cell 100a and the cell 100b are displaced, and the bus bar 110 that connects the cells to each other is cut, thereby restraining a short circuit. Such a relationship may be established between all adjacent cells 100 included in the electricity storage module 11.

In the second restraint mechanism, it is only required that at least one of the facing faces 17 have a shape that extends outward in the width direction from the bottom wall 14a toward the upper side. That is, the first facing face 17a may have a shape that extends outward in the width direction from the bottom wall 14a toward the upper side, or the second facing face 17b may have a shape that extends outward in the width direction from the bottom wall 14a toward the upper side. Both of the facing faces 17 may have a shape that extends outward in the width direction from the bottom wall 14a toward the upper side.

Each facing face 17 may, for example, be bent (refer to FIG. 8A), be straight (refer to FIG. 8B), or be curved (not shown).

The restraint mechanism (electrode terminal) may be configured to face outward of the vehicle 1 when the electricity storage apparatus 10 is mounted on the vehicle 1. Disposing the restraint mechanism on the outer side of the vehicle 1 to which a large force is input when an impact is applied to the vehicle 1 makes it possible to improve safety against a collision.

A wire harness (not shown) may be provided in a space between at least one of the facing faces 17 and the electricity storage module 11. The wire harness, for example, electrically connects a plurality of electricity storage apparatuses 10 mounted on the vehicle 1 to each other. Providing the wire harness in the space of the electricity storage apparatus having the above-mentioned restraint mechanism makes it possible to restrain damage of the wire harness even when an impact is applied to the vehicle 1.

The wire harness may be provided in a space between the first facing face 17a and the electricity storage module 11, or the wire harness may be provided in a space between the second facing face 17b and the electricity storage module 11. The wire harness may be provided in a space between each of the facing faces 17 and the electricity storage module 11.

The electricity storage apparatus 10 may further include a cooler (not shown). The cooler can cool the electricity storage module 11. The cooler may include, for example, a refrigerant channel. The cooler may be disposed, for example, between the upper case 13 and the electricity storage module 11. The cooler may be disposed, for example, between the lower case 14 and the electricity storage module 11.

What is claimed is:

1. An electricity storage apparatus comprising:
an electricity storage module; and
a housing, wherein:
the housing houses the electricity storage module;
the electricity storage module includes a plurality of cells;
each of the cells has a height direction, a width direction, and a thickness direction;
each of the cells has a shape that is longer in the width direction than in the height direction and the thickness direction;
an end in the width direction is provided with an electrode terminal;
the housing includes an upper case and a lower case;
the upper case includes a top wall;
the lower case includes a bottom wall, a pair of end walls, and a pair of side walls;
the bottom wall faces the top wall;
each of the end walls includes a facing face facing the electrode terminal;
the electricity storage apparatus has a restraint mechanism that restrains damage of the electrode terminal; and
the restraint mechanism has at least one of a rib extending from at least one of the facing faces toward the electricity storage module and a shape of at least one of the facing faces extending outward in the width direction from the bottom wall toward an upper side.

2. The electricity storage apparatus according to claim 1, wherein the restraint mechanism is configured to face outward of a vehicle when the electricity storage apparatus is mounted on the vehicle.

3. The electricity storage apparatus according to claim 1, wherein:
the cells are stacked in the thickness direction;
between adjacent ones of the cells, a bus bar connects the adjacent cells to each other;
the end walls include a first end wall and a second end wall;
the first end wall includes a first facing face facing the electrode terminal;
the second end wall includes a second facing face facing the electrode terminal;
the second end wall faces the first end wall;
the second facing face faces the first facing face;
the electricity storage apparatus is provided with a first rib extending from the first facing face toward the electricity storage module, and a second rib extending from the second facing face toward the electricity storage module; and
in adjacent ones of the cells, the first rib is provided facing one of the adjacent cells, and the second rib is provided facing the other one of the adjacent cells.

4. The electricity storage apparatus according to claim 1, wherein a wire harness is provided in a space between at least one of the facing faces and the electricity storage module.
